(19) United States
(12) Patent Application Publication
(10) Pub. No.: US 2004/0106036 A1
(43) Pub. Date: Jun. 3, 2004

(54) Battery Pack for an Electric Tool

(75) Inventors: Wilhelm Geis, Leutenbach (DE); Dieter Hirt, Winnenden (DE)

Correspondence Address: GUDRUN E. HUCKETT, LONSSTR. 53, WUPPERTAL, 42289, DE

(73) Assignee: ATLAS COPCO ELECTRIC TOOLS GMBH, Winnenden (DE)

(21) Appl. No.: 10/604,742

(22) Filed: Aug. 14, 2003

Related U.S. Application Data
(63) Continuation of application No. PCT/EP02/01552, filed on Feb. 14, 2002.

(30) Foreign Application Priority Data
Feb. 15, 2001 (DE) 20102675.9

(51) Int. Cl. H01M 2/10

(52) U.S. Cl. 429/99; 429/187; 429/123; 429/97

(57) ABSTRACT

A battery pack for an electric power tool has a protective housing and battery cells received in the protective housing. The protective housing has a first housing side provided with a receiving shoe for mechanical attachment to a free end of the power tool handle. The receiving shoe has electrical contacts for connecting to electrical lines of the drive motor of the power tool. The protective housing has a second housing side providing a support surface extending substantially in a direction of the longitudinal center axis of the tool housing. The battery cells in the protective housing are arranged in the longitudinal direction behind one another in at least one row. At least one of the battery cells is displaced laterally such that a displaced row portion is formed and the support surface has a widened support surface portion transversely to the longitudinal center axis of the tool housing.

### CROSS REFERENCE TO RELATED APPLICATIONS

This is a continuation of international application PCT/EP02/01552 having an international filing date of Feb. 14, 2002, not published in English under PCT Article 21(2), and now abandoned.

### BACKGROUND OF INVENTION

1. Field of the Invention

The invention relates to a battery pack for electrically operated power tools, in particular, cordless screwdrivers, cordless power drill or the like, comprising an electric motor arranged in a tool housing and a handle connected to the tool housing. The battery pack comprises a protective housing receiving the individual battery cells of the battery pack, wherein the protective housing comprises a receiving shoe on one housing side for mechanically connecting the battery pack to the free end of the handle. The receiving shoe has electrical contacts for connecting to battery pack to electrical lines connected to the drive motor, wherein the housing side facing away from the receiving shoe and forming a bottom of the battery pack has a support surface which extends substantially in the direction of a longitudinal center axis of the tool housing and wherein the individual battery cells in the protective housing are essentially arranged sequentially one after another in the longitudinal direction of the tool housing.

2. Description of the Related Art

Such electrically operated power tools, for example, cordless screwdrivers, cordless power drills, and similar tools, are comprised substantially of a tool housing containing the electrical drive motor as well as a pistol grip-shaped handle connected to the tool housing. For supplying electrical energy to the power tool, a battery pack is connected to the free end of the handle preferably by a snap-on connection, wherein the battery pack is connected by electrical contacts with electrical lines of the drive motor.

In order to provide a sufficient power reserve for the power tool, nickel cadmium cells have been used in the past which have a power range of approximately 1.4 to 2.2 Ah. As a result of the height and the diameter of the cylindrical battery cells, relatively heavy, tall and, because of the serial arrangement, long battery packs result. When such a power pack or battery pack is connected by a snap-on connection via the receiving shoe to the free end of the handle, a large portion of the battery pack length projects past the handle forwardly in the direction toward the drill chuck. Accordingly, the center of gravity of the power pack is in front of the handle (relative to the drill chuck) and causes a tilting moment which must be compensated by the user by introducing a force into the handle. When positioning the power tool by means of the bottom (acting as a support surface) of the battery pack onto a surface, only a limited upright stability (stability of the power tool when in the upright position) is provided in the direction transversely to the longitudinal center axis of the tool housing because the foot print of the battery pack is relatively narrow as a result of the arrangement of two rows of battery cells adjacent to one another.

### SUMMARY OF INVENTION

It is an object of the present invention to configure the power pack or battery pack of the aforementioned kind such that the user will have a sufficient output available while the power tool has a minimal tilting moment and a high upright stability when seated on the support surface of the battery pack.

In accordance with the present invention, this is achieved in that within a row of individual battery cells extending in the longitudinal direction of the tool housing at least one of the battery cell is arranged laterally displaced such that the support surface within a partial section of the protective housing is widened transversely to the longitudinal center axis of the tool housing.

The invention is characterized by an advantageous combination of mechanical and electrical requirements. By means of the individual battery cell, laterally displaced within a row of individual battery cells, the support surface of the battery pack transversely to the longitudinal center axis of the tool housing is enlarged so that, when placing the power tool with the support surface of the battery pack onto a surface, an increased upright stability of the power tool itself is provided. The displaced arrangement of battery cells within one row so as to form a displaced row portion not only enlarges the support surface area but, at the same time, the length of the battery pack in the direction of the longitudinal center axis of the tool housing is reduced. This is so because in the direction of the longitudinal center axis of the housing, the individual battery cells can be positioned closer together since the displaced arrangement causes the outer circumference of neighboring battery cells to be positioned closer together. Particularly in a configuration of two rows of adjacently positioned battery cells the dead space otherwise present between the battery cells can be used by the displaced position of the individual battery cells; in this way, the reduction of the length of the battery pack results.

Because of the displaced position of individual battery cells within the row of battery cells, space for additional battery cells can be provided at the same time so that, despite the shortened length of the battery pack, more battery cells can be arranged therein so that the output voltage can be increased and, in this way, the capacity of the battery pack can be increased.

Since the widened support surface in a plan view is positioned spatially in front of the receiving shoe, the shortening of the length of the battery pack relative to the portion of the battery pack projecting from the handle has the effect that the center of gravity of the battery cells positioned in front of the handle is moved closer to the handle. The tilting forces caused by the battery pack are reduced by positioning the center of gravity closer to the handle.

In the displaced portion of a row of battery cells, two battery cells can be advantageously arranged adjacent to one another wherein the displacement is such that it is expediently approximately half the diameter of an individual battery cell. A high packaging density is ensured when all individual battery cells are identical, i.e., within one power pack individual battery cells of the same construction and same spatial configuration and size are used.

In a plan view onto a power pack an arrangement of battery cells results which corresponds approximately to a ‘Balkenkreuz’ (cross having four short, wide arms). Twelve individual battery cells can be provided; five each of the battery cells form a row, respectively, wherein in each row two battery cells are laterally displaced by the same amount toward the same side. This portion of laterally displaced battery cells is located spatially between the two ends of the protective housing of the battery pack in the longitudinal direction of the tool housing. The free space between the laterally displaced battery cells can be used for inserting additional battery cells when the lateral displacement corresponds to at least half the diameter of an individual battery cell.

### BRIEF DESCRIPTION OF DRAWINGS

FIG. 1 is a perspective illustration of an electrical power tool; illustrated is a cordless screwdriver.

FIG. 2 shows an enlarged perspective illustration of the battery pack according to the invention.

FIG. 3 is a plan view onto the battery pack according to FIG. 2.

FIG. 4 is a side view of the battery pack according to FIG. 2.

### DETAILED DESCRIPTION

The battery pack according to the invention is designed for electrically operated power tools comprising an electrical motor 2 arranged in a tool housing 1 and a handle or grip 3 attached to the tool housing 1. The handle is embodied as a so-called pistol grip and is secured approximately centrally relative to the tool housing 1. The axis 4 of the tool grip and the longitudinal center axis 5 of the tool housing are positioned at an angle 6 relative to one another; this angle 6 is greater than 90 degrees and opens toward the front end of the power tool. At the upper portion of the handle 3 a pushbutton 7 for switching the electric motor 2 on and off is arranged. A battery pack 10 is attached to the end 8 of the handle 3 facing away from the housing 1. The battery pack is provided for supplying electrical energy to the drive motor 2. The output shaft 9 of the motor 2 is positioned approximately along the longitudinal center axis 5 of the tool housing 1.

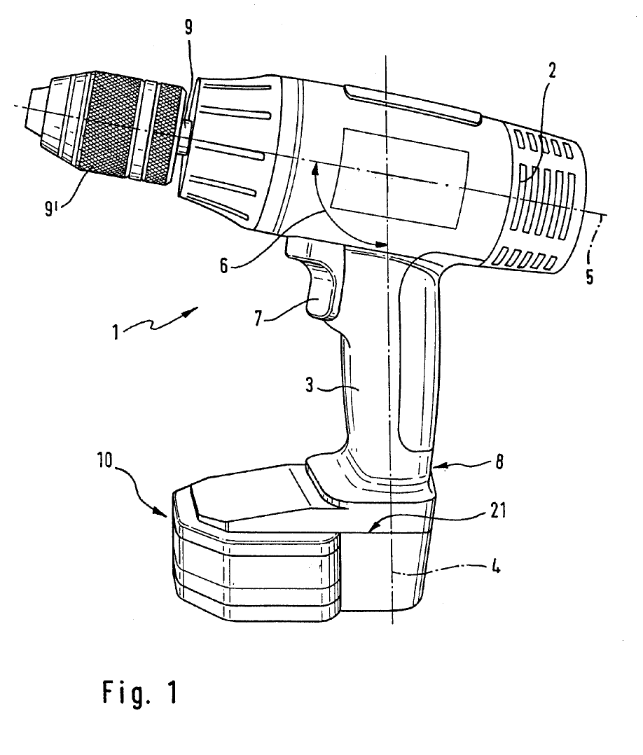

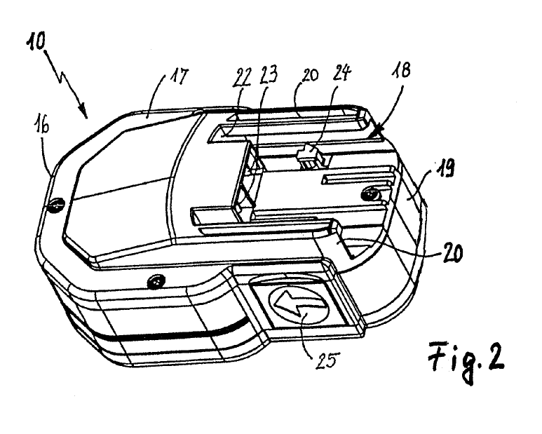

The battery pack 10 is comprised of a protective housing 16 receiving the individual battery cells 11 to 14 and 11′ to 14′. At its flat housing side 17 facing the handle 3, it is provided with a receiving shoe 18 which opens to the rear end face 19. The free end 8 of the handle 3 is pushed from the open end face 19 into the receiving shoe 18. Lateral guide rails 20 engage a corresponding guide groove 21 (FIG. 1) of the handle in order to provide a positive-locking connection of the handle 3 with the receiving shoe 18 and the battery pack 10. On the end face 22 opposite the open end of the receiving shoe 18 electrical contacts 23 are provided; after pushing the end 8 of the handle 3 into the receiving shoe 18, the contacts 23 provide an electrically conducting connection with the electrical lines provided in the handle 3 and connected to the drive motor 2. For a captive connection of the battery pack 10 to the end 8 of the handle 3, locking noses 24 are provided in the receiving shoe 18 which engage matching locking openings at the free end 8 of the handle 3 in a positive-locking way so as to provide a snap-on connection and ensure a safe (captive) attachment of the battery pack 10 on the handle 3. The locking elements 24 are movable by means of lateral actuating means 25 into a release position; in this position, the end 8 can be pulled out of the receiving shoe 18.

The power pack 10 has a support surface 26 on the side that is facing away from the flat housing side 17 provided with the receiving shoe 18; the support surface 26 is used to place the power tool onto a surface. As illustrated in FIG. 1, the battery pack housing projects in the direction of the longitudinal center axis 5 of the tool housing 1 in the direction to the output shaft 9 and extends thus substantially below the electric motor 2 in the direction toward the tool chuck 9′.

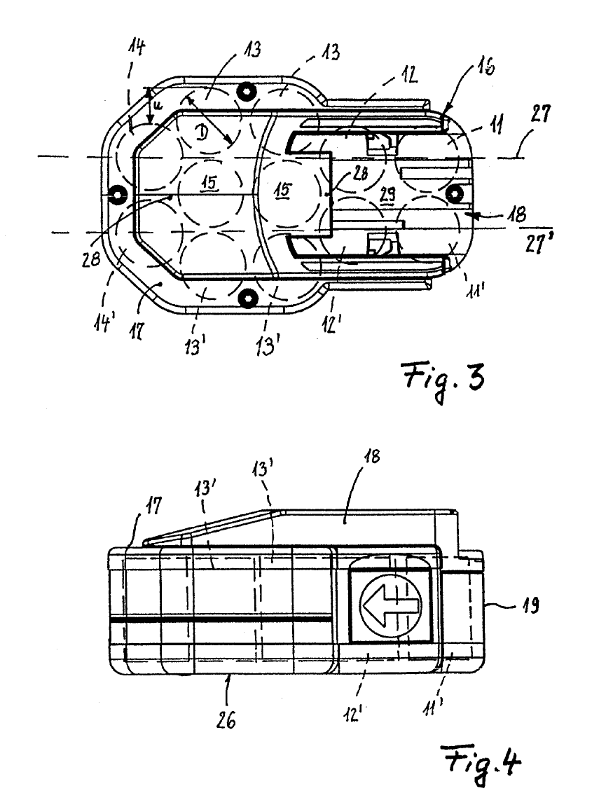

In a plan view according to FIG. 3, the protective housing 16 has a larger extension transversely to the longitudinal center axis 5 and to the output shaft 9 in the area outside of the receiving shoe 18 than in the area of the receiving shoe 18 or the end 8 of the handle 3. In this connection, the configuration of the protective housing 16 is determined by the arrangement of the individual battery cells 11, 11′ to 14, 14′ and 15.

The individual battery cells are arranged such that they form essentially two rows 27 and 27′ which extend in their basic orientation in the longitudinal direction of the motor shaft 9 in the direction forwardly to the tool chuck (drill chuck) 9′. In the area of the receiving shoe 18 the battery cells 11, 12 and 11′, 12′ of the rows 27 and 27′ are positioned preferably at the same level adjacent to one another and sequentially behind one another in the direction of the longitudinal center axis 5 of the tool housing 1. Individual battery cells 13, 13′ adjoin the battery cells 12, 12′ and are transversely displaced relative to the longitudinal center axis 5 of the tool housing 1, i.e., are laterally displaced and form a displaced row portion. The lateral displacement u corresponds preferably to half the diameter D of an individual battery cell so that between the displaced individual battery cells 13 and 13′ of the rows 27 and 27′ a free space for additional individual battery cells 15 of preferably the same configuration and size as the others is provided. As a result of this arrangement, transversely to the longitudinal center axis 5 of the tool housing 1 a widened support surface portion 26 is provided so that the upright stability of the power tool, when placed onto a surface with the support surface of the battery pack 10, is significantly increased. The arrangement has also the advantage that the weight of the individual battery cells 13, 13′ and 15 is positioned closer to the axis 4 of the handle 3 so that a reduced tilting moment results. The power tool can be guided and used more comfortably; it requires less force and cause less fatigue when being used.

As a result of the lateral displacement u matching half the size of the diameter D of an individual battery cell, it is also achieved that the individual battery cells 15 can project into the free space 28 of the neighboring battery cells 12, 12′ and 14, 14′ of the rows 27 and 27′. As a result of their spatial configuration, cylindrical individual battery cells, when in an upright arrangement adjacent to one another, delimit a dead space 29 between them, as illustrated in FIG. 3 between the battery cells 11, 12, 11′, and 12′. Because of the displaced arrangement of the battery cells 13, 13′, neighboring battery cells in the longitudinal direction of the rows 27 and 27′ can be arranged closer to the battery cells 12, 12′ or 14, 14′ so that in a side view the contours of the neighboring battery cells overlap one another. The dead space is minimized. In this way, there is also a reduction of the length of a row 27, 27′ without this reducing the number of individual battery cells. In the illustrated embodiment, twelve battery cells are arranged in the battery pack 10; these twelve battery cells have a reduced length in the longitudinal direction of a row 27, 27′ in comparison to an arrangement of five individual battery cells which are aligned in a straight line within a row, respectively. The cross with four wide arms (‘Balkenkreuz’) formed by the battery cell rows 27, 27′, as illustrated in FIG. 3 in a plan view, thus provides an enlarged support surface and reduced length and moreover provides advantages as a result of the center of gravity being positioned closer to the handle.

In the illustrated embodiment, the cross (‘Balkenkreuz’) is formed of six battery cells 13, 13′, 15 displaced by the displacement u relative to the longitudinal center axis of the rows 27 and 27′. The rows 27 and 27′ end with individual battery cells 14 and 14′ positioned so as to closely neighbor the displaced battery cells 13, 13′ and 15 and project into the free space 28 formed between them.

In practice, with the inventive arrangement of the battery cells a higher voltage of the battery pack can be provided so that the capacity of the individual battery cells can be lowered without this limiting in any way the utilization of the power tool by the user. The higher voltage in combination with the reduced capacity provides a sufficient power reserve for the user. As a result of the reduced capacity and higher power density, the individual battery cells in regard to their height are smaller so that also the height of the battery pack itself can be reduced. As an overall result, this provides a light-weight, smaller battery pack with enlarged support surface while a satisfactory capacity is still provided for the user.

It may be expedient to employee instead of the battery cells 14, 14′ hollow members or dummies inasmuch as a reduced supply voltage, for example, 12 volts, is sufficient. The hollow bodies or dummies used as spacers are significantly lighter weight-wise than individual battery cells 14 or 14′ so that the weight can be reduced even more and the tilting moment, which must be counteracted by the user, is also reduced.

While specific embodiments of the invention have been shown and described in detail to illustrate the inventive principles, it will be understood that the invention may be embodied otherwise without departing from such principles.

What is claimed is:

1. A battery pack for an electric power tool that comprises a tool housing with an electric motor arranged therein and a handle connected to the tool housing; the battery pack comprising:
a protective housing;
individual battery cells received in the protective housing;
wherein the protective housing has a first housing side provided with a receiving shoe, wherein the receiving shoe is configured for mechanical attachment to a free end of the handle of the power tool;
wherein the receiving shoe has electrical contacts configured to connect to electrical lines connected to the drive motor of the power tool;
wherein the protective housing has a second housing side providing a support surface extending substantially in a direction of a longitudinal center axis of the tool housing when the battery pack is mounted on the handle;
wherein the individual battery cells in the protective housing are arranged in a longitudinal direction of the tool housing sequentially behind one another in at least one row;
wherein at least one of the individual battery cells arranged in the at least one row is displaced laterally relative to the longitudinal direction such that a displaced row portion is formed and the support surface over a portion of the protective housing has a widened support surface portion in a direction transversely to the longitudinal center axis of the tool housing.

2. The battery pack according to claim 1, wherein the widened support surface portion, when viewed in a plan view when the battery pack is attached to the handle, is located in front of the receiving shoe.

3. The battery pack according to claim 1, wherein the receiving shoe is configured to completely receive an end of the handle.

4. The battery pack according to claim 1, wherein two of the individual battery cells are positioned adjacent to one another in the displaced row portion.

5. The battery pack according to claim 1, wherein the individual battery cells together form a cross.

6. The battery pack according to claim 1, wherein twelve of the individual battery cells are provided and wherein six of the twelve individual battery cells are laterally displaced relative to the at least one row.

7. The battery pack according to claim 1, wherein the displaced row portion is located spatially between ends of the protective housing provided in the longitudinal direction of the tool housing.

8. The battery pack according to claim 1, wherein in the displaced row portion the individual battery cells are laterally displaced by a displacement matching approximately half a diameter of the individual battery cells.

9. The battery pack according to claim 1, wherein all of the individual battery cells of the battery pack are identical.
